(19) United States
(12) Patent Application Publication
(10) Pub. No.: US 2012/0161721 A1
(43) Pub. Date: Jun. 28, 2012

(54) POWER HARVESTING SYSTEMS

(76) Inventor: Antony Kalugumalai Neethimanickam, Bangalore (IN)

(21) Appl. No.: 13/327,808

(22) Filed: Dec. 16, 2011

(30) Foreign Application Priority Data
Dec. 24, 2010 (IN) 3947/CHE/2010

(51) Int. Cl. H02J 7/00

(52) U.S. Cl. 320/167

(57) ABSTRACT

A power harvesting system for providing energy to operate a coupled electrical device. The power harvesting system comprises a charging device and a wireless switching device operably coupled to the charging device. The charging device is configured for charging the wireless switching device and comprises a first RF transceiver for communicating with the wireless switching device and a power transmitter for imparting power to the wireless switching device. The wireless switching device comprises a second RF transceiver for communicating with the charging device, a power receiver operably coupled to the power transmitter, the power receiver configured for receiving power from the power transmitter, a rectifier circuit coupled to the power receiver, the rectifier circuit configured for converting the received power into DC energy and at least one ultra-capacitor electrically coupled to the rectifier circuit, the ultra-capacitor configured for storing the DC energy.

### FIELD OF INVENTION

This invention relates generally to contactless power supplies, and more specifically to contactless power supplies capable of communicating with any devices receiving power from the contactless power supplies.

### BACKGROUND OF THE INVENTION

Majority of the portable electronic devices that are used on a daily basis rely on rechargeable batteries to power the devices. Devices such as cameras, remote controllers, cell phones, laptops, portable music players, and cordless telephones are designed to operate using power from a battery, and in many instances, a rechargeable battery. The low power consumption of the electronic devices may make it feasible to use batteries with a smaller storage capacity and to charge these batteries more frequently.

A problem with a device powered by a rechargeable battery is that the device can become discharged before the user realizes a need to recharge the battery. As the device becomes inoperable due to a lack of charge in the battery, the user must couple the battery (either directly or indirectly through the device) to a charging unit for an extended period of time until the battery is recharged. As the battery recharges, the device remains inoperable, leaving the user unproductive relative to use of the device and potentially frustrated in their experience with the device.

On the other hand, several different types of rechargeable chemical batteries have been used in uninterruptible power supplies. All of the known chemical batteries, however, in addition to short lifespans, suffer from several other drawbacks including susceptibility to changes in temperature and shock, as well as overcharging and discharging inefficiency. Chemical batteries require significant maintenance and are potentially damaging to the environment when disposed of because they contain toxic chemicals. Moreover, traditional chemical batteries operate in a very narrow voltage range. For example, a 12 volt battery typically operates within a 3 volt range from approximately 10.7 volts to approximately 12.7 volts. Once a battery gets below 10.7 volts, any energy stored in the battery is not usable and is lost.

Hence there exists a need for an efficient and reliable system for powering electronic devices.

### BRIEF DESCRIPTION OF THE INVENTION

The above-mentioned shortcomings, disadvantages and problems are addressed herein which will be understood by reading and understanding the following specification.

In one embodiment, a power harvesting system for providing energy to operate a coupled electrical device is provided. The power harvesting system comprises a charging device and a wireless switching device operably coupled to the charging device. The charging device is configured for charging the wireless switching device and comprises a first RF transceiver for communicating with the wireless switching device and a power transmitter for imparting power to the wireless switching device. The wireless switching device comprises a power receiver operably coupled to the power transmitter, the power receiver configured for receiving power from the power transmitter, a rectifier circuit coupled to the power receiver, the rectifier circuit configured for converting the received power into DC energy and at least one ultra capacitor electrically coupled to the rectifier circuit, the ultra capacitor configured for storing the DC energy. Further, the power transmitter and the power receiver communicate using one of an Infrared data association (IrDA) communication and a radio frequency (RF) communication.

In another embodiment, an induction power harvesting system comprising a charging device and a wireless switching device operably coupled to the charging device is provided. The charging device is configured for charging the wireless switching device. The charging device comprises a first RF transceiver for communicating with the wireless switching device, a first microcontroller coupled to the RF transceiver, the first microcontroller configured to control the operation of the charging device and a primary induction coil for imparting power to the wireless switching device. The wireless switching device comprises a secondary induction coil inductively coupled to the primary induction coil, the secondary induction coil configured for receiving power from the primary induction coil, a rectifier circuit coupled to the secondary induction coil, the rectifier circuit configured for converting the received power into DC energy and at least one ultra capacitor electrically coupled to the rectifier circuit, the ultra capacitor configured for storing the DC energy.

In yet another embodiment, an RF power harvesting system comprising a charging device and a wireless switching device operably coupled to the charging device is provided. The charging device is configured for charging the wireless switching device. The charging device comprises an RF power transmitter for transmitting RF power to the wireless switching device and a first RF transceiver for communicating with the wireless switching device. The wireless switching device comprises an RF power receiver operably coupled to the RF power transmitter, the RF power receiver configured for receiving the RF power transmitted from the RF power transmitter, a rectifier circuit coupled to the RF power receiver, the rectifier circuit configured for converting the received power into DC energy and at least one ultra capacitor electrically coupled to the rectifier circuit, the ultra capacitor configured for storing the DC energy.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a block diagram of a power harvesting system for providing energy to operate a coupled electrical device, as described in one embodiment;

FIG. 2 shows a block diagram of an induction power harvesting system as described in an embodiment; and

FIG. 3 shows a block diagram of an RF power harvesting system as described in an embodiment.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The invention provides systems for harvesting power and subsequent storage of the harvested power in an ultra capacitor or a super capacitor.

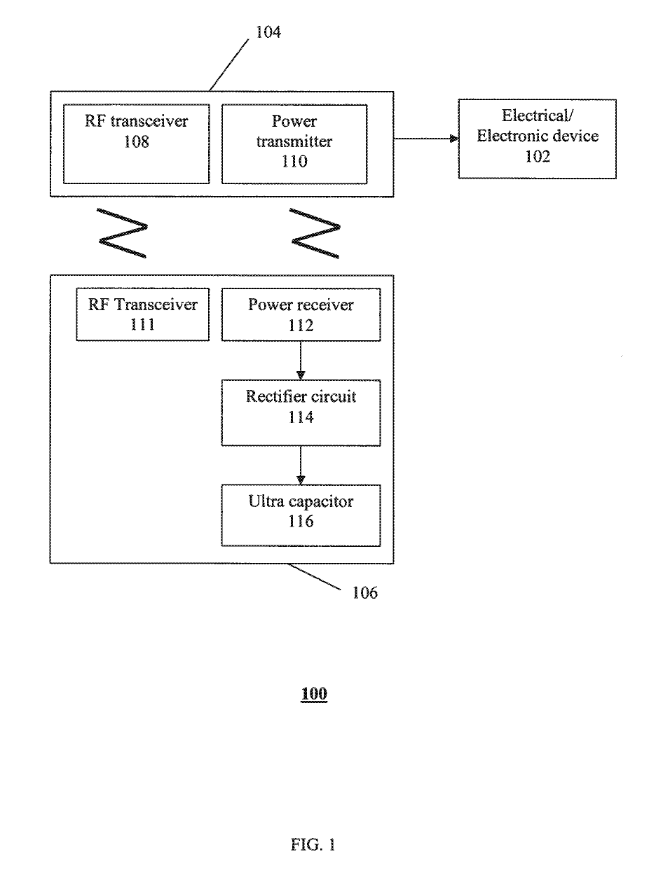

Referring now to FIG. 1, in one embodiment, a power harvesting system 100 for providing energy to operate a coupled electrical or electronic device 102 is provided. The power harvesting system 100 comprises a charging device 104 and a wireless switching device 106 operably coupled to the charging device 104. The charging device 104 is configured for charging the wireless switching device 106. The charging device 104 comprises a first RF transceiver 108 for communicating with the wireless switching device 106 and a power transmitter 110 for imparting power to the wireless switching device 106. The wireless switching device 106 comprises a second RF transceiver 111 for communicating with the charging device 104, a power receiver 112 operably coupled to the power transmitter 110, the power receiver 112 configured for receiving power from the power transmitter 110, a rectifier circuit 114 coupled to the power receiver 112, the rectifier circuit 114 configured for converting the received power into DC energy, at least one ultra capacitor 116 electrically coupled to the rectifier circuit 114, the ultra capacitor 116 configured for storing the DC energy.

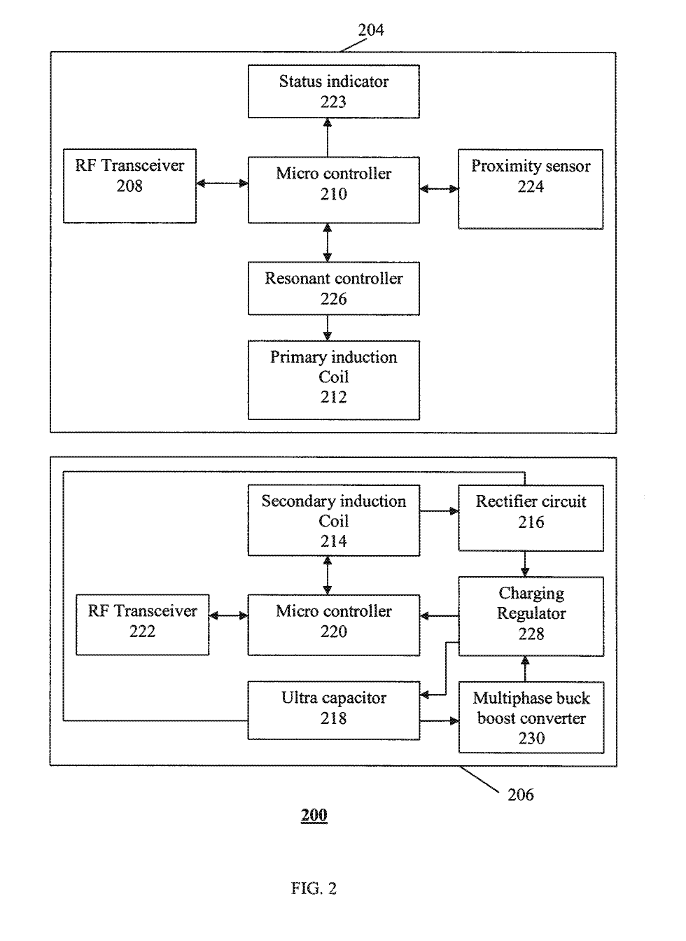

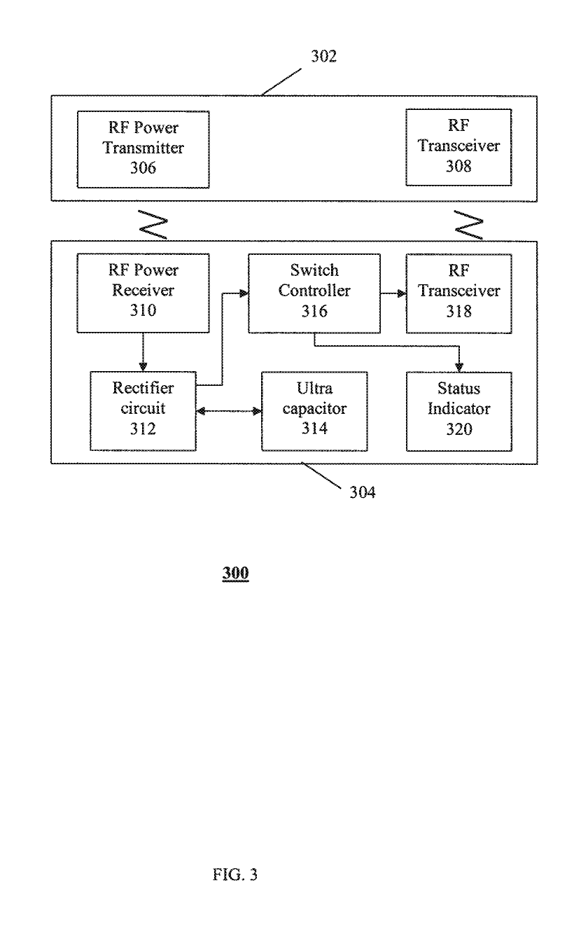

Further, the power transmitter 110 and the power receiver 112 communicate using one of an Infrared data association (IrDA) communication and a radio frequency (RF) communication. The operation of the power harvesting system 100 is described in more detail in connection with FIGS. 2 and 3.

In one embodiment, the ultra capacitor can be charged by electromagnetic induction. In this case, the power harvesting system 100 includes a primary induction coil and a secondary induction coil, which is placed in close proximity to the primary induction coil. The primary induction coil for example may be an electromagnetic transmitting coil. The secondary induction coil is positioned to intercept the electromagnetic flux lines of the primary induction coil. The operation of the induction power harvesting system is described in more detail in connection with FIG. 2.

Accordingly, in one exemplary embodiment, an induction power harvesting system 200 shown in FIG. 2 is provided. The induction power harvesting system 200 comprises a charging device 204 and a wireless switching device 206 operably coupled to the charging device 204. The charging device 204 is configured for charging the wireless switching device 206. The charging device 204 comprises a first RF transceiver 208 for communicating with the wireless switching device 206, a first microcontroller 210 coupled to the RF transceiver, the first microcontroller 210 configured to control the operation of the charging device 204 and a primary induction coil 212 for imparting power to the wireless switching device 206. The wireless switching device 206 comprises a secondary induction coil 214 inductively coupled to the primary induction coil 212, the secondary induction coil 214 configured for receiving power from the primary induction coil 212, a rectifier circuit 216 coupled to the secondary induction coil 214, the rectifier circuit 216 configured for converting the received power into DC energy and at least one ultra capacitor 218 electrically coupled to the rectifier circuit 216, the ultra capacitor 218 configured for storing the DC energy.

In this embodiment, the charging device 204 and the wireless switching device 206 are configured for Infrared data association (IrDA) communication for exchanging information on the status of the charge stored in the ultra capacitor 218. For this purpose, the charging device 204 further comprises a proximity sensor 224 coupled to the first microcontroller 210, the proximity sensor 224 configured for detecting presence of the wireless switching device 206 within the communication range of the primary induction coil 212.

In operation, the induction power harvesting system waits until it determines that a load is present before applying power to the primary induction coil 212. This will save power and is enabled by the proximity sensor 224 that senses the presence of the secondary induction coil 214 when it is placed into proximity with the primary induction coil 212.

The charging device 204 further comprises a status indicator 223 coupled to the first microcontroller 210, the status indicator 223 configured for monitoring the charging status of the wireless switching device 206. The status indicators 223 are well known in the art and may comprise one of an LED and LCD display or such similar display devices.

The charging device 204 further comprises a resonant controller 226 coupled to the first microcontroller 210, the resonant controller 226 configured for controlling the charging of the wireless switching device 206. The resonant controller 226 provides maximum energy transfer and efficiency under different coupling factors and different load and charging conditions.

The resonant controller 226 is coupled to the primary induction coil 212 for transferring power to the wireless switching device 206. The wireless switching device 206 sends power information to the first microcontroller 210. The first microcontroller 210 then modifies the operation of the resonant controller 226 in response to the power information. Thus, the first microcontroller 210 can precisely calibrate the power supplied to the secondary induction coil 214 for operating the wireless switching device 206 thereby providing high efficiency power transfer from the charging device 204 to the wireless switching device 206.

The resonant controller 226 comprises a resonant circuit having a variable inductance and a variable capacitance and a plurality of transistors that are selectively actuated by the first microcontroller 210 to control the values of the variable inductance and variable capacitance that form the resonant circuit. In general operation, the first microcontroller 210 is programmed to receive power information from the wireless switching device 206 and is programmed to separately adjust the one or more transistors to cycle through the range of capacitance values and inductance values available in the resonant circuit. By modifying the inductance of variable inductor and the capacitance of variable capacitor 218, the resonant frequency of resonant circuit can be changed. The first microcontroller 210 continues to monitor the power information from the wireless switching device 206 while adjusting the capacitance and inductance values to determine which values provide optimum current to the primary induction coil 212. The first microcontroller 210 then locks the values into the optimum settings.

The wireless switching device 206 further comprises a second microcontroller 220 coupled to ultra capacitor 218 and a second RF transceiver 222 coupled to the second microcontroller 220. The second microcontroller 220 is configured for controlling the operation of wireless switching device 206 and the second RF transceiver 222 configured for communicating with the charging device 204.

The second microcontroller 220 is capable of varying the impendence of the secondary induction coil 214. The second microcontroller 220 varies the variable impedance of the secondary induction coil 214 based upon information from the charging device 204. The second microcontroller 220 may also disable the operation of the wireless switching device 206 based upon information from the charging device 204. Thus, the wireless switching device 206 could also be operated at a high efficiency. Thus, the induction power harvesting system allows the optimization of both the charging device 204 as well as the wireless switching device 206 coupled to the charging device 204.

The wireless switching device 206 further comprises a charging regulator 228 coupled to the one or more ultra capacitors 218, the charging regulator 228 configured for regulating an energy current that is used to charge the one or more ultra capacitors 218. The one or more ultra capacitors 218 are capable of being charged during normal operation of the coupled electrical device. Further, each of the one or more ultra capacitors 218 is rated for between about 3 to 10 volts. It will be apparent to an individual skilled in the art that a variety of ultra capacitors 218 from various manufactures may be used to implement the invention.

The ultra capacitor 218, instead of storing energy electrochemically, stores it in an electric field. Ultra capacitors 218 have multiple advantages over conventional batteries, including a lifetime of over 10 years, resistance to changes in temperature, shock, overcharging, and discharging efficiency. They require less maintenance than conventional batteries and are light on the environment when disposed because they lack toxic chemicals. Their energy, however, is retrieved in the form of a voltage, which decreases as the ultra capacitor 218 discharges. On the other hand, the coupled electrical devices require a constant voltage level, which the ultra capacitor 218, by itself, cannot provide.

As the ultra capacitors 218 have extremely low internal impedance, which is independent of their charged state, the ultra capacitors 218 will accept as much current as the charging regulator 228 provides. In addition, the ultra capacitors 218 are sensitive to voltages greater than their ratings. The charging regulator 228 may need to limit the voltage in a precise manner. The charging regulator 228 may need to be designed to a variety of conditions required by the various ultra capacitors 218 selected.

For the purpose of limiting the voltages supplied to the ultra capacitors 218, the wireless switching device 206 further comprises a multiphase buck boost converter 230 electrically coupled to the charging regulator 228 and to the one or more ultra capacitors 218. The multiphase buck boost converter 230 is configured for providing a relatively constant voltage from the stored energy of the one or more ultra capacitors 218.

As the ultra capacitor 218 stores energy over an entire range of voltages; thus the energy needs to be extracted by discharging the ultra capacitor 218 to the lowest possible voltage. A characteristic of the boost converter 230 is that the output voltage may be greater than the input voltage. Although a “buck” type converter 230 may be utilized, such a converter 230 will only discharge the capacitor 218 to the desired output voltage, which may leave unused energy in the capacitor 218. Due to the design of a “buck” converter 230, the output may have to be less than the input. However a “buck-boost” type converter 230 will allow the output voltage to be above and below the input voltage from the ultra capacitor 218. The “buck-boost” type converter 230 will generally allow a greater voltage range from the capacitor 218. The “buck-boost” or a polyphase “buck-boost” converter 230 may be limited by the design of the “buck-boost” converter 230.

The switching device 206 may further comprise an enabler (not shown) coupled to the rectifier circuit 216, multiphase buck/boost converter 230 and to the charging regulator 228. The enabler (not shown) forms an optimum energy transfer so as to provide a small enough intermediate energy to satisfactorily operate electronic devices 102 at fixed time intervals while also storing any additional unused energy on the ultra capacitor 218 where a given voltage may not be present when needed.

If the AC power supplied is interrupted, the second microcontroller 220 signals the multiphase buck boost converter 230 to start draining power from the ultra capacitors 218 and supply power to the enabler (not shown). The multiphase buck boost converter 230 needs to supply a relatively constant voltage to the connected electronic device 102 using the power stored in the ultra capacitors 218 that supply power over a range of voltages. Depending on the ultra capacitors 218 used and the desired efficiency, the boost converter 230 may use a variety of designs and configurations as are apparent to an individual skilled in the art.

Further, the charging device 204 may also have a communication interface for communicating with the electrical/electronic device 102. The communication interface may be any of a number of well-known or proprietary interfaces such as USB, fire wire, or RS-232, WIFI, infrared, blue tooth, or cellular.

The first and second micro controllers 210 and 220 would create a communication link between the electrical/electronic device 102 and the wireless switching device 206 by way of the first and second RF transceivers 208 and 222. The first and second RF transceiver 208 and 222 communicate with the first and second microcontrollers 210 and 220 respectively via a serial communication protocol, the serial communication protocol being selected from the group consisting of Inter-Integrated Circuit (“I2C”), controller Area Network (“CAN”), Process Field Bus (“ProfiBus”), Serial Peripheral Interface (“SPI”) and Universal Serial Bus (“USB”).

The operation of the RF power harvesting system is described in more detail in connection with FIG. 3. Accordingly, as is shown in FIG. 3, an RF power harvesting system 300 comprising a charging device 302 and a wireless switching device 304 operably coupled to the charging device 302 is provided. The charging device 302 is configured for charging the wireless switching device 304. The charging device 302 comprises an RF power transmitter 306 for transmitting RF power to the wireless switching device 304 and a first RF transceiver 308 for communicating with the wireless switching device 304. The wireless switching device 304 comprises an RF power receiver 310 operablly coupled to the RF power transmitter 306, the RF power receiver 310 configured for receiving the RF power transmitted from the RF power transmitter 306, a rectifier circuit 312 coupled to the RF power receiver 310, the rectifier circuit 312 configured for converting the received power into DC energy and at least one ultra capacitor 314 electrically coupled to the rectifier circuit 312, the ultra capacitor 314 configured for storing the DC energy.

The wireless switching device 304 further comprises a switch controller 316 coupled to the rectifier circuit 312 and a second RF transceiver 318 coupled to the switch controller 316. The switch controller 316 is configured for controlling the operation of wireless switching device 304 and the second RF transceiver 318 is configured for communicating with the charging device 302.

The RF power harvesting system further comprises a status indicator 320 coupled to the switch controller 316, the status indicator 320 configured for detecting and indicating the presence of the wireless switching device 304 within the communication range of the RF power transmitter 306.

It may be noted that many of the components described in FIGS. 2 and 3 are similar to the components described in FIG. 1 and perform substantially the same function as that of the components sharing similar names.

In one embodiment, the RF power harvesting system has a means for receipt of ambient energy from the environment for energizing the power storage devices such as the ultra capacitors 314. The RF power harvesting system comprises one or more RF power transmitter 306-receiver combinations (referred to hereafter as RF power transceiver) and rectifier circuit 312 for converting the ambient energy into DC power for energizing the one or more ultra capacitors 314. The RF power transmitter 306-receiver combination is tuned to produce the maximum DC energy at the output of the rectifier circuit 312.

The RF power transceiver is tuned to produce the maximum DC energy at the output of the rectifier circuit 312. The RF power transceiver can be an antenna array comprising multiple broadband antennae each tuned to a different portion of the frequency spectrum in order to harvest RF energy from a broad RF spectrum. Alternately, the RF power transceiver can be an antenna array comprising multiple broadband antennae in the same space each tuned to a specific portion of the frequency spectrum in order to maximize the harvest RF energy from an RF spectrum in same physical space. An RF combiner or balun can be used to combine the input signals from two or more antennae directed to the rectifier circuit 312. The use of multiple broadband antennae of this invention would minimize the problems associated with a resonant antenna or antennae that need to be manually or electronically tune to harvest the RF energy efficiently.

The RF power transceiver for efficient energy harvesting may have characteristics that are different from those of a RF communications transceiver (referred to hereafter as RF transceiver). The RF transceiver is configured to be used as a transmitting or receiving antenna such as a monopole, a dipole, bow-tie or loop antenna. Moreover, the RF transceiver is to be carefully designed in order to give the optimum performance in communications (AM and FM radio, Television, Wi-Fi, for example).

In one embodiment, at least a portion of the ultra capacitor 314 may be enclosed by an electromagnetic shield in order to shield the portion of the ultra capacitor 314 from the RF electromagnetic field. The RF electromagnetic field may be a microwave field operating in a frequency range between 1 and 100 GHz. The ultra capacitor 314 may be in the form of a thin sheet, with the RF transceiver disposed on a major surface of the sheet.

Each of the first microcontroller 210, second microcontroller 220 and switch controller 316 may be any one of a multitude of commonly available microcontrollers programmed to perform the functions that are described herein. As is known, the microcontroller may have a ROM (read only memory) and RAM (random access memory) on the chip. Further, the microcontroller may have a series of analog and digital outputs for controlling the various functions within the inductive power harvesting system.

In one exemplary embodiment, the wireless switching device 304 includes a wireless foot switch and a wireless hand switch. In the embodiment describing the RF power harvesting system, the power for the wireless foot switch/hand switch is derived from the RF power harvesting and during the conditions where the wireless switching device 304 is idle, the wireless switching device 304 is configured to store the harvested power in the ultra capacitor 314. This harvested power stored in the ultra capacitor 314 may help the wireless switching device 304 in cases where the RF power harvested is insufficient.

In one exemplary embodiment, the power harvesting systems 100, 200 and 300 described herein can be used in a medical device. More specifically, the power harvesting systems can be incorporated in a medical imaging device or a surgical device. The wireless switching device may include a hand switch and a foot switch used in the medical imaging device to power and operate the medical imaging device including controlling the process of irradiation.

Further, the power harvesting systems described herein enable the extended operation of the wireless switching devices while requiring no additional power or re-charging. This is very helpful for the wireless switching device used in the medical environment such as an operation theatre.

In one exemplary embodiment, the wireless switching device may be a wireless hand switch and the charging device 302 may be hand switch holder. The hand switch is very much useful in the operation theatre environment where the access to the foot switch or the control panel is restricted by space or movement. The wireless hand switch is placed in the hand switch holder whenever the wireless hand switch is not in use. In the induction power harvesting system described herein, the electrical energy from the hand switch holder is harvested, transmitted in the form of induction energy, converted to DC form and stored in the ultra capacitor 314. The stored energy in the ultra capacitor 314 is sufficient to power the wireless hand switch when the wireless hand switch is in normal operation or when the hand switch is not placed in the hand switch holder.

This induction power harvesting is advantageous due to high-energy transfer capabilities of the induction power harvesting and is also economical.

The RF power harvesting system is particularly useful in case of foot switches used in a medical environment in which the distance and direction of placement of the foot switches is not predictable. The foot switch is typically placed on the floor with obstacles in between to the power receiver 310. The RF power transmitter 306 and RF power receiver 310 combination employed herein charges the foot switch irrespective of distance and direction of placement of the foot switch thereby eliminating the need to dock the foot switch for re-charging

In one exemplary embodiment, the wireless switching device may be a wireless hand switch and the charging device 302 may be hand switch holder. This embodiment enables the wireless hand switch to harvest induction power from the hand switch holder. The hand switch holder comprises the primary induction coil 212. The primary induction coil 212 is exited by a high frequency AC power (In the range of few MHz). The wireless hand switch comprises a secondary induction coil 214 with required VA rating and turns ratio to produce a high frequency AC power due to induction from the primary induction coil 212.

The induced high frequency AC power is subsequently rectified and used to charge the ultra capacitor 218, which will store the electrical energy and supply the second microcontroller 220 and the second RF transceiver 222.

Some of the advantages of the power harvesting systems 100, 200 and 300 described herein are provided below.

The power harvesting systems 100, 200 and 300 described herein eliminates the need to charge or change the battery incorporated in the electrical/electronic device 102.

The storage capacity of the ultra capacitor is high compared to a typical rechargeable battery thereby providing very high charging and discharging cycles compared to a battery back up. Further, the ultra capacitor is generally low weight compared to a battery.

Further, the ultra capacitors may also be permanently incorporated or sealed inside the electronic devices, with none of the electrical connections being accessible from the outside. This may help in making the wireless switching device IP68 rated that enables easy cleaning and sterilizing the switching device, which is especially helpful when the switching device is used in a medical environment such as the operation theatre.

Further, the ultra capacitors when sealed within the switching device need no external electrical contacts for charging. The absence of external electrical contacts reduces the efforts required for maintaining the switching device.

In various embodiments of the invention, power-harvesting systems for an electrical and/or electronic device are described. However, the embodiments are not limited and may be implemented in connection with different applications. The application of the invention can be extended to other areas, for example power supplies or backup power supplies. The design can be carried further and implemented in various forms and specifications.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A power harvesting system for providing energy to operate a coupled electrical device, the power harvesting system comprising:
a charging device and a wireless switching device operably coupled to the charging device, the charging device configured for charging the wireless switching device, the charging device comprising:
a first RF transceiver for communicating with the wireless switching device; and
a power transmitter for imparting power to the wireless switching device;
and wherein the wireless switching device comprises:
a second RF transceiver for communicating with the charging device;
a power receiver operably coupled to the power transmitter, the power receiver configured for receiving power from the power transmitter;
a rectifier circuit coupled to the power receiver, the rectifier circuit configured for converting the received power into DC energy; and
at least one ultra capacitor electrically coupled to the rectifier circuit, the ultra capacitor configured for storing the DC energy.
wherein the power transmitter and the power receiver communicate using one of an Infra red data association (IrDA) communication and a radio frequency (RF) communication.

2. The power harvesting system of claim 1, wherein the one or more ultra capacitors are capable of being charged during normal operation of the coupled electrical device.

3. The power harvesting system of claim 1, wherein the power transmitter is a primary induction coil and the power receiver is a secondary induction coil inductively coupled to the primary induction coil.

4. The power harvesting system of claim 3, wherein the charging device further comprises a first microcontroller coupled to the first RF transceiver, the first microcontroller configured to control the operation of the charging device.

5. The power harvesting system of claim 4, wherein the charging device and the wireless switching device are capable of Infrared data association (IrDA) communication for exchanging information on the status of the charge stored in the ultra capacitor.

6. The power harvesting system of claim 5, wherein the charging device further comprises a proximity sensor coupled to the first microcontroller, the proximity sensor configured for detecting presence of the wireless switching device within the communication range of the primary induction coil.

7. The power harvesting system of claim 3, wherein the wireless switching device further comprises a second microcontroller coupled to the second RF transceiver, the second microcontroller configured to control the operation of the wireless switching device.

8. The power harvesting system of claim 1, wherein the power transmitter is an RF power transmitter and the power receiver is an RF power receiver communicatively coupled to the RF power transmitter.

9. The power harvesting system of claim 8, wherein the wireless switching device further comprises a switch controller coupled to the rectifier circuit, the switch controller configured for controlling the operation of the wireless switching device.

10. The power harvesting system of claim 9, further comprises a status indicator coupled to the switch controller, the status indicator configured for detecting and indicating the presence of the wireless switching device within the communication range of the RF power transmitter.

11. An infrared power harvesting system comprising:
a charging device and a wireless switching device operably coupled to the charging device, the charging device configured for charging the wireless switching device, the charging device comprising:
a first RF transceiver for communicating with the wireless switching device;
a first microcontroller coupled to the RF transceiver, the switch controller configured to control the operation of the charging device; and
a primary induction coil for imparting power to the wireless switching device;
and wherein the wireless switching device comprises:
a secondary induction coil inductively coupled to the primary induction coil, the secondary induction coil configured for receiving power from the primary induction coil;
a rectifier circuit coupled to the secondary induction coil, the rectifier circuit configured for converting the received power into DC energy;
at least one ultra capacitor electrically coupled to the rectifier circuit, the ultra capacitor configured for storing the DC enemy;
a second microcontroller coupled to ultra capacitor, the second microcontroller configured for controlling the operation of wireless switching device; and
a second RF transceiver coupled to the second microcontroller, the second RF transceiver configured for communicating with the charging device.

12. The inductive power harvesting system of claim 11, wherein the charging device further comprises a status indicator coupled to the first microcontroller, the status indicator configured for monitoring the charging status of the wireless switching device.

13. The inductive power harvesting system of claim 11, wherein the charging device further comprises a proximity sensor coupled to the first microcontroller, the proximity sensor configured for detecting presence of the wireless switching device within the communication range of the primary induction coil.

14. The inductive power harvesting system of claim 11, wherein the charging device and the wireless switching device are capable of Infrared data association (IrDA) communication for exchanging information on the status of the charge stored in the ultra capacitor.

15. The inductive power harvesting system of claim 11, wherein the charging device further comprises a resonant controller coupled to the first microcontroller, the resonant controller configured for controlling the charging of the wireless switching device.

16. The inductive power harvesting system of claim 11, wherein the wireless switching device further comprises a charging regulator coupled to the one or more ultra capacitors, the charging regulator configured for regulating an energy current that is used to charge the one or more ultra capacitors.

17. The inductive power harvesting system of claim 16, wherein each of the one or more ultra capacitors is rated for between about 3 to 10 volts.

18. The inductive power harvesting system of claim 16, wherein the wireless switching device further comprises a multiphase buck-boost converter electrically coupled to the charging regulator and the one or more ultra capacitors, the multiphase buck or boost converter configured for providing a relatively constant voltage from the stored energy of the one or more ultra capacitors.

19. The inductive power harvesting system of claim 16, wherein the first and second RF transceivers communicate with the first and second microcontrollers respectively via a serial communication protocol, the serial communication protocol being selected from the group consisting of Inter-Integrated Circuit (“I2C”), controller Area Network (“CAN”), Process Field Bus (“ProfiBus” Serial Peripheral Interface (“SPI”) and Universal Serial Bus (“USB”).

20. An RF power harvesting system comprising;
a charging device and a wireless switching device operably coupled to the charging device, the charging device configured for charging the wireless switching device, the charging device comprising:
an RF power transmitter for transmitting RF power to the wireless switching device; and
a first RF transceiver for communicating with the wireless switching device;
and wherein the wireless switching device comprises:
an RF power receiver operablly coupled to the RF power transmitter, the RF power receiver configured for receiving the RF power transmitted from the RF power transmitter;
a rectifier circuit coupled to the RF power receiver, the rectifier circuit configured for converting the received power into DC energy;
at least one ultra capacitor electrically coupled to the rectifier circuit, the ultra capacitor configured for storing the DC energy;
a switch controller coupled to the rectifier circuit, the switch controller configured for controlling the operation of wireless switching device; and
a second RF transceiver coupled to the switch controller, the second RF transceiver configured for communicating with the charging device.

21. The RF power harvesting system of claim 20, further comprises a status indicator coupled to the switch controller, the status indicator configured for detecting and indicating the presence of the wireless switching device within the communication range of the RF power transmitter.
